(19) United States
(12) Patent Application Publication
(10) Pub. No.: US 2007/0138926 A1
(43) Pub. Date: Jun. 21, 2007

(54) Method for optimizing lamp spectral output

(76) Inventors: Peter W. Brown, Twinsburg, OH (US); Ashfaqul Chowdhury, Broadiew Heights, OH (US); Rajasingh Israel, Westlake, OH (US)

Correspondence Address: Timothy E. Nauman, 7th Floor, 1100 Superior Avenue, Cleveland, OH, 44114-2579, US

(21) Appl. No.: 11/303,106

(22) Filed: Dec. 16, 2005

(51) Int. Cl. H01K 1/30; H01J 61/40; H01J 1/62

(52) U.S. Cl. 313/110; 313/489; 313/111; 313/112

(57) ABSTRACT

A lamp (10) includes a housing (12) with a light source (30, 32) disposed within the housing. Two or more light modulating elements (80, 82, 84, 86) are associated with different components of the lamp, such as a reflector housing (70), an envelope (36), a lens (74), and a shroud (76). Each of the light modulating elements modulates the visible light emitted by the source intermediate the source and an exterior of the housing. One of the light modulating elements modulates light in at least one region of the visible portion of the electromagnetic spectrum differently from another of the light modulating elements. In this way, the light emitted by the source may be tailored by using different properties of each of the light modulating elements.

### BACKGROUND

The exemplary embodiment relates to optical interference coatings for lamps and finds particular application in conjunction with the optimization of the spectral output of a tungsten filament lamp. It should be appreciated that the invention is also applicable to a variety of other light sources.

Lighting products employing tungsten filaments are widely used in a variety of applications, including lamps for industrial, commercial, and domestic applications. Such lamps include a filament tube containing a halide fill, such as methyl bromide or iodide. On excitation of the tungsten filament, the light source emits a characteristic color of light, typically in the yellow to white region of the electromagnetic spectrum. While this color is suited to many applications, it is often desirable for certain applications to generate light with other apparent colors and associated color temperatures. For example, in certain applications it is desirable to output a spectrum and color temperature similar to that of daylight or to produce a more specialized lamp with red, green, or blue dominant tones, for use in projection televisions, dance, entertainment, or art studio applications, and in theaters.

U.S. Pat. Nos. 5,418,419; 5,666,017; 5,977,694; and 6,611,082 disclose the production of lamps approximating a daylight spectrum by coating either the reflector portion of a lamp or the filament tube of the lamp with an optical interference coating. The coating is a highly complex arrangement of layers of differing refractive indices and uses computer modeling techniques to achieve the desired output. The result is usually a compromise since it is extremely difficult or often impossible to optimize the output over the entire useable range of the electromagnetic spectrum.

### BRIEF DESCRIPTION

In accordance with one aspect of the exemplary embodiment, a lamp includes a housing. A light source is disposed within the housing. A plurality of light modulating elements is provided. Each of the light modulating elements modulates the visible light emitted by the source intermediate the source and an exterior of the housing. A first of the light modulating elements modulates light in at least one region of the visible portion of the electromagnetic spectrum differently from a second of the light modulating elements.

In another aspect, a lamp includes a housing and a light source disposed within the housing. At least three light modulating elements are provided. Each of the light modulating elements modulates at least a portion of the light emitted by the source intermediate the source and an exterior of the housing such that light emitted by the lamp includes light modulated by the three light modulating elements

In another aspect, a lamp includes a housing and a light emitting source disposed within the housing. The lamp optionally includes an envelope which surrounds the light source and which transmits at least a portion of the light from the source. The lamp optionally includes a shroud, spaced outwardly from the envelope, which transmits at least a portion of the light from the source. The lamp optionally includes a reflective surface which reflects at least a portion of the light emitted by the source. The lamp optionally includes a cover lens which closes an end of the housing and which transmits at least a portion of the light emitted by the source. A first optical interference coating is associated with a first of the envelope, the shroud, the cover lens, and the reflective surface and a second optical interference coating is associated with a second of the envelope, the shroud, the cover lens, and the reflective surface.

In another aspect, method of achieving a desired spectral distribution includes modulating light emitted by a source with a first light modulating element and modulating light emitted by the source with a second light modulating element. The second light modulating element is spaced from the first light modulating element to receive light modulated by the first light modulating component. The method further includes outputting light modulated by at least the first and second light modulating elements to achieve light of the desired spectral distribution.

### BRIEF DESCRIPTION OF THE DRAWINGS

FIG. 1 is a side sectional view of a lamp according to the exemplary embodiment;

FIG. 2 is a schematic view of a ray diagram lamp according to the one aspect of the exemplary embodiment; and

FIGS. 3-6 demonstrate the combined effect of two light modulating elements: FIG. 3 illustrates the light output from a source prior to modulation; FIG. 4 shows the light from the source as modulated by a first light modulating element; FIG. 5 shows the light from the source as modulated by a second light modulating element; and FIG. 6 shows the output of the lamp after modulation by the two light modulation elements.

### DETAILED DESCRIPTION

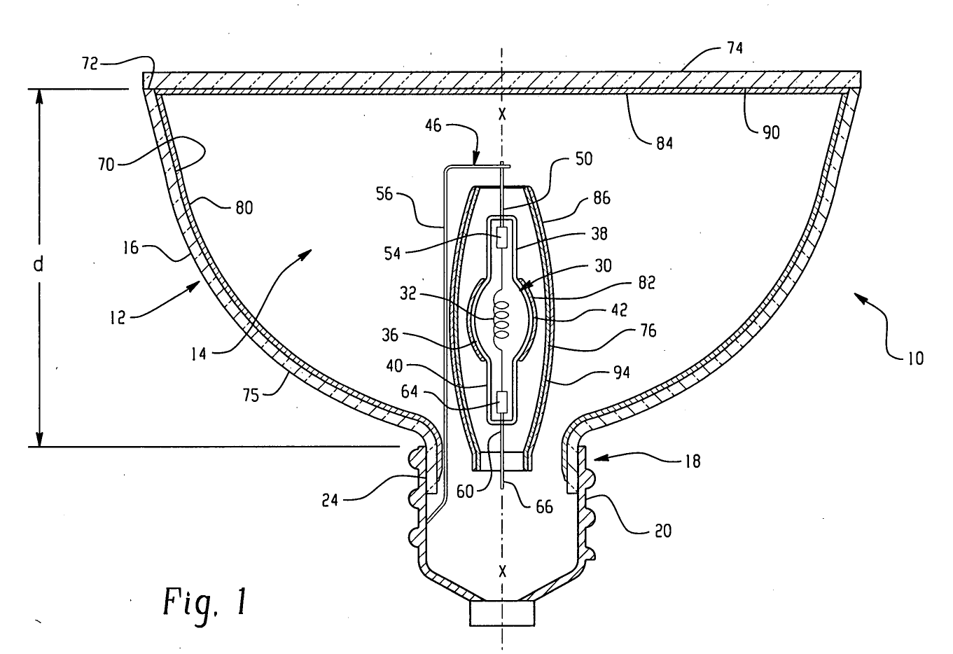

With reference to FIG. 1, a lighting system 10, such as a lamp, includes a reflector housing 12, formed from pressed glass, plastic, or other suitable material, which defines an internal cavity 14. The housing 12 includes a concave reflector portion 16 and a neck portion 18 having a longitudinal extending conical configuration as shown. The neck portion can be secured to a metal base shell or cap 20 in a conventional manner, such as by adhesive joinder with a suitable epoxy cement 24.

A light source 30, such as a tungsten-halogen light source, is disposed within the internal cavity 14. The illustrated light source 30 is aligned with its major dimension along the axis X of the lamp 10. A representative tungsten halogen light source 30 includes an energizable element 32, such an axially aligned tungsten coiled filament, which is hermetically sealed within an elongated filament tube or envelope 36 formed from aluminosilicate glass, ceramic, or other light-transmissive material. The lamp envelope encloses a gaseous ionizable fill, which contains at least one rare gas, such as krypton or xenon, and a vaporizable halogen substance, such as an alkyl halide compound (e.g., methyl bromide). Other fill compositions are also contemplated, such as metal halides, mercury, and combinations thereof. The envelope includes upper and lower tubular portions 38, 40, which are generally cylindrical in shape. These taper outwardly to a wider, central bulbous portion 42 which may be elliptical, spherical, or the like. The center of the tungsten filament 32 resides approximately at the focal point of the reflector, within the bulbous portion of the envelope. Other light sources are contemplated, such as an arc discharge which is generated between electrodes.

When energized, light is emitted from the filament and at least a portion of the light passes through the envelope. As used herein the term “light” encompasses wavelengths in the infrared and ultraviolet regions of the electromagnetic spectrum, as well as visible light. For example, wavelengths from about 150 nm to about 2.5 micrometers may be considered as light.

The terms “upper” and “lower” and similar terms are used with respect to the lamp as shown in the FIGURES. It should be appreciated that, in use, the lamp may be inverted from the position shown, with the base 20 screwed into a ceiling fixture, or the like.

The filament coil 32 is physically suspended within the lamp envelope by an assembly 46 of lead-wire electrical conductors. An upper lead-in wire 50 is connected with the filament via a connector 54, such as a molybdenum foil and externally connected to a supporting lead 56 which provides a rigid support for the envelope. Similarly, a lower lead-in wire 60 is connected with a lower end of the filament via a foil connector 64 and electrically connected with another portion of the cap via an external lead 66. The support lead 56 is formed from stainless or other suitable material and is electrically connected with the cap. It will be appreciated that other lamp configurations are also contemplated. For example, both electrodes may enter the bulb portion 42 from the same direction.

The reflector portion 16 has a reflective surface 70 which may be parabolic, elliptical, or the like. The illustrated reflective surface 70 is an interior surface and may be provided by a reflective coating, such as a layer of primarily aluminum or silver, on an underlying substrate. Or the reflector housing may comprise a reflective material which provides the reflective surface 70. The reflective surface 70 intercepts and reflects visible spectrum radiant energy in the range of about 400-700 nanometers. For example, the reflective surface 70 may reflect at least 80% of light in the 400-700 nanometer range. The reflective surface 70 may also reflect light of other wavelengths outside the visible range, such as light within the infrared or ultraviolet portions of the electromagnetic spectrum. The filament 32 can be positioned within the reflector 12 so that at least about 50% of the visible spectrum radiant energy exiting the envelope 30 is directed towards the reflector surface 70. In various aspects, the filament is positioned in order that at least about 60% of the visible spectrum radiant energy is directed towards the reflector surface 70, and, in one embodiment, the filament is positioned so that at least about 90% of the visible spectrum radiant energy is directed towards the reflector surface.

In one embodiment, the focal point of the reflector is located substantially below a top surface 72 of the reflector 12 such that the distance between the focal point of the reflector and the top surface is at least about 50% of the depth d of the reflector and in one specific embodiment is about 60% of the depth of the reflector. As will be apparent to those skilled in the art, as the depth of the reflector increases, the percentage of visible spectrum radiant energy which is intercepted by the reflector surface increases. The reflector housing 12 is optionally closed at its upper end by a lens or cover member 74, which may be formed from a light transmissive material, such as glass or plastic.

Optionally, the lamp includes a shroud 76. The shroud may be formed from a light transmissive material, such as glass, which is of a sufficient thickness and/or strength to contain pieces of glass in the event of a rupture of the envelope 30.

The lamp 10 includes a plurality of light modulating elements 80, 82, 84, 86 which work in concert to modulate light from the filament 32. By modulation, it is meant that the modulating element perceptibly modifies the spectral distribution of the light which strikes the modulating element such that the light which is output by the modulating element (by transmission or reflection) has a different spectral distribution. The modification can result in an increase in the light output, at a particular wavelength, or in an attenuation. In general, the spectral distribution is modified by two or more of the light modulating elements in at least the visible range of the spectrum, but may also be modified in the infrared and or ultraviolet regions of the spectrum.

The Reflectance R or Transmittance T of the light modulating element (depending on whether the light modulating element is on or associated with a transmitting surface, such as the envelope, or a reflecting surface, such as the reflector) at a given wavelength (λ) may be expressed as a ratio of the received light (the light prior to the transmission or reflectance), i.e.,:

$$R ( λ ) = \frac{Reflected energy at wavelength λ}{Incident energy at wavelength λ}$$

$$T ( λ ) = \frac{Transmitted energy at wavelength λ}{Incident energy at wavelength λ}$$

where, R(λ) and T(λ) are integrated functions over the entire range of corresponding angles of incidence, reflection, and transmission.

In some embodiments, the modulation by a modulating element 80, 82, 84, 86 is such as result in an average change in R(λ) or T(λ) of at least 5% for at least 10% of the wavelengths in the visible region of the spectrum in nanometers, between 380 and 780 nanometers.

The two or more light modulating elements 80, 82, 84, 86 may be selected from optical interference coatings, absorption coatings, dispersions in a transmissive element, and combinations thereof. The light modulating elements 80, 82, 84, 86 modulate a least one region differently and may each primarily modulate a different region or regions of the electromagnetic spectrum. For example, a first of the light modulating elements may reduce the amount of light output (either through transmission or reflectance) in the 400-420 nanometer range while a second light modulating element may reduce the light output (either through transmission or reflectance) in the 680-780 nanometer range. The first light modulating element may provide little or no modulation in the 680-780 nanometer range and vice versa. In this way, each light modulating element contributes only a portion of the total modulation of the light which occurs between the filament 32 and an exterior of the lamp 10.

Optical interference coatings, also known as dichroic filters, generally comprise multiple layers, e.g., at least five layers, and often twenty or more layers of alternating lower and higher refractive index. Layers 1, 3, 5 etc may thus be formed from a first material having a first refractive index and layers 2, 4, etc of a different material having a different refractive index. Suitable materials for forming optical interference coatings include materials which are substantially light transmissive, such as magnesium fluoride, silicon dioxide, niobium pentoxide, tantalum pentoxide, silicone sulfide, and the like and other materials as disclosed, for example, in U.S. Pat. Nos. 4,588,923; 4,663,557; 4,689,519; 4,734,6145; and 5,138,219. The low refractive index material may have a refractive index in the range of from about 1.40-1.70 and the high refractive index material may have a refractive index of from about 2.0-2.2.

The optical interference coatings may be applied using evaporation or sputtering techniques and also by chemical vapor deposition (CVD) and low pressure chemical vapor deposition (LPCVD) processes. Some attempts to make such interference filters have employed solution deposition techniques such as is disclosed in U.S. Pat. No. 4,701,663.

Where two or more of optical interference coatings are used as light modulating elements they may differ in at least one of: a number of optical interference layers, a thickness of at least one of the optical interference layers, and a composition of at least one of the optical interference layers.

Absorption coatings or dip coatings can comprise one or more layers of the same material and may include a pigment which absorbs a portion of the light passing through the coating. Where two or more absorption coatings are used as light modulating elements they may differ in the composition of the dip coating, such as in the type of pigment used.

Where the light modulating element is in the form of a dispersion it may be a neodymium glass or other spectrally modulating doped/formulated quartz, glass or transparent ceramic which forms all or a part of the envelope, lens, reflector housing, or shroud of the lamp. As is used in the specification, the term “transparent” refers to the property of transmitting radiation without appreciable scattering or diffusion.

In general, the light modulating elements are all spaced from each other, e.g., by a non-light modulating light transmissive medium of the lamp, such as air, another gas, a vacuum, or a substrate (e.g., the envelope, the lens, or the shroud) on which the light modulating element or elements are supported.

A first light modulating element 80 may be in the form of a light modulating coating, such as an optical interference coating or a dip coating, which is formed on the interior surface 70 of the reflector housing. Alternatively, or additionally, the coating 80 may be formed on an exterior surface 75 of the reflector housing, for example, where the reflective surface 70 is formed on the exterior surface of the reflector housing. The coating 80 is selected to provide the reflector with a specific set of reflectance properties, so that when emitted from the lighting system 10, the combined reflected and non-reflected light has a desired spectral output.

A second light modulating element 82 may be in the form of an optical interference coating or dip coating on at least a portion of the envelope 36. In the illustrated embodiment, the entire envelope surface is coated with a coating 82 and thus all light emitted by the source and which exits the lamp is modulated by the coating 82. In other embodiments, only a portion of the envelope is coated such that a portion of the light is modulated while a second portion of the light passes from the envelope unmodulated. Although FIG. 1 shows the second optical interference coating 82 as being on an outer surface of the filament tube 36, it should be appreciated that the coating may also be formed on the inner surface. In other embodiments, a first coating is formed on an exterior surface of the lamp and a second coating is formed on an interior surface of the lamp.

A third light modulating element 84 may be in the form of a light modulating coating, such as a dip coating or optical interference coating on a surface 90 of the lens 74. For example, the inner surface 90 of the lens is coated with an optical interference coating similar to that use on the envelope, which modifies the spectral distribution of light passing through it. Alternatively or additionally, the lens 74 may be made of a neodymium glass or other spectrally modulating doped/formulated quartz, glass or transparent ceramic. When not used with an optical interference coating, the lens 74 may be coated with an ultraviolet filter coating.

A fourth modulating element 86 may be in the form of a light modulating coating, such as a dip coating or optical interference coating on a surface 94 of the shroud 76. In the case of the shroud, the interference or other coating 86 may be formed on inner or outer surfaces, or on both surfaces of the shroud.

The exemplary embodiment makes use of at least two complimentary light modulating elements 80, 82, 84, 86, such as optical interference coatings, to modulate the output of the lighting system. By complimentary it is meant that the two, or more, interference coatings are each optimized to modulate/attenuate a certain different portion of the electromagnetic spectrum. By having each of the coatings focus on a different region or regions of the spectrum, each of the regions can be optimized more efficiently to produce the overall desired spectral output.

In one embodiment, the lighting system includes up to four light modulating elements selected from a first optical interference coating 80 on the reflector, a second optical interference coating 82 on the filament tube, a third optical interference coating 86 on the lens, and y a fourth optical interference coating 86 on the shroud. Each of the optical interference coatings is optimized for a different region of the electromagnetic spectrum so that the total output from the lighting system is as close as possible to a desired spectral distribution curve, for example, that of an approximation of daylight. Having at least two, and in one embodiment at least three or four optical interference coatings, in this way, allows a closer approach to the desired spectral output than has been previously achieved with a single coating on the filament tube or on the reflector surface.

As is known to those skilled in the art, a multiplicity of “daylight” spectra exist. It will be appreciated that “daylight” has no defined spectrum, but is generally understood to have a color temperature in the range of about 4200K or higher which closely matches an actual daylight spectrum as could be measured during the daylight hours of the day. The spectral output to be achieved, such as daylight may be expressed as a plot of wavelength against energy, as compared with that of the energy distribution of the light source to be used.

The combination of optical interference coatings or other light modulating elements can be optimized to modulate the light output to approximate the desired spectral output. The optimization system used may be weighted to focus on those areas of the electromagnetic spectrum to which the eye is most sensitive. While the exemplary embodiment is described with particular reference to a tungsten filament lamp, it will be appreciated that the light sources may also be used, such as fluorescent or incandescent sources.

Although the exemplary lighting system 10 is described with respect to four optical interference coatings or other light modulating elements 80, 82, 84, 86, it will be appreciated that improvements can also be made by using two or three optical interference coatings. For example, an interference coating on the filament tube and an interference coating on the lens or, an interference coating on the filament tube combined with an interference coating on the shroud. Other combinations are also contemplated.

It will also be appreciated that the lamp 10 need not be configured as for FIG. 1. For example, a lamp may be formed without a reflector and wherein the envelope is enclosed within a housing formed from a light transmissive material, such as glass. In this embodiment, a light modulating element may be formed on the housing. In other embodiments, the lamp may be formed without an envelope or without a cover lens.

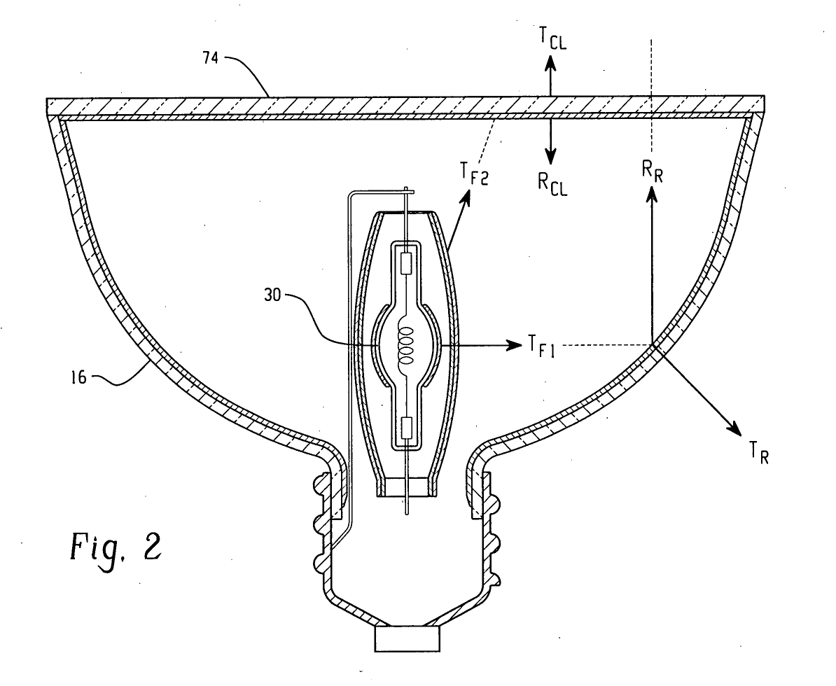

With reference now to FIG. 2, the case in which optical interference coatings 80, 82, 84, are found on filament tube 30, the reflector 16, and the lens 74 is exemplified by ray tracing. Arrows show the transmittance (T) and reflectance (R) from each of these coatings. T_{F1} represents the fraction of visible spectral energy emitted from the filament tube 30 which is directed towards the reflector 16 and T_{F2} reflects the fraction of visible spectral energy emitted from the filament tube which is not directed towards the reflector. R_{R} is the reflectance of the reflector 16 and T_{R} is the transmittance of the reflector. R_{CL} represents reflectance of the cover lens 74 reflecting energy back into the lighting system. T_{CL} is the transmittance of the cover lens 74 towards the outside of the lighting system. At any given wavelength, (λ), T_{F} is the total amount of natural umnodulated, unmodified spectral emission of the filament tube 30, i.e., prior to interaction of the light with any of the light modulating elements. At any given wavelength
T_{F1}(λ)=C₁×T_{F}×MF_{F}; and (1)
T_{F2}(λ)=C₂×T_{F}×MF_{F}, (2)

where MF_{F} is a modulation function describing the performance of the optical interference coating 82 on the filament tube and C₁ and C₂ are constants indicating the relative amounts of energy emitted from the filament tube and directed toward and away from the reflector respectively. The values of C₁ and C₂ can be determined experimentally, or though modeling and depend on the structure of the lamp. C₁ and C₂ are generally not significantly affected by the modulating elements.

In general, where there is little or no absorption by the coating,
T_{F1}(λ)+T_{F2}(λ)=T_{F} (3)

For the reflector, the reflectance, as a function of wavelength R(λ), is given by the expression:
R(λ)=T_{F1}×MF_{R} (4)

where MF_{R} is a modulation function of the reflector with input of spectral radiant energy of T_{F1} directed toward the reflector and output of R_{R} directed toward the cover lens.

If T_{R}(λ)=% transmittance of reflector, as a function of wavelength;

R_{CL}(λ)=the % reflectance of the cover lens (reflecting light back into to the lamp) as a function of wavelength; and

T_{CL}(λ)=% transmittance of the cover lens (transmitted to the outside of the lamp), as a function of wavelength

For the cover lens, the transmittance of the cover lens as a function of wavelength,
T_{CL}(λ)=(T_{F2}+R_{R})×MF_{CL}, (5)
where MF_{CL} is a modulation function describing the performance of the optical interference coating on the cover lens to manipulate certain regions of the visible energy spectrum, to yield the desired performance of the lighting system. Thus,
T_{CL}(λ)=C₂×T_{F}×MF_{F}+[C₁×T_{F}×MF_{F}]×MF_{R})×MF_{CL} (6)

For the lighting system as a whole, the transmittance (to the exterior of the lamp) for the total system at any given wavelength can be represented as follows:
T_{SYSTEM}(λ)=T_{CL}=(C₂×T_{F}×MF_{F}+[C₁×T_{F}×MF_{F}]×MF_{R})×MF_{CL} (7)
Thus, by selection of combinations of different modulating functions, a desired total transmittance of the system can be achieved. The different modulation functions can be achieved by selecting different compositions etc. for the various light modulating elements 80, 82, 84, 86, for example, by selection of MF_{F}, MF_{R} and MF_{CL} values which all differ by at least 5% for at least 10% of all wavelengths in the visible range of the spectrum.

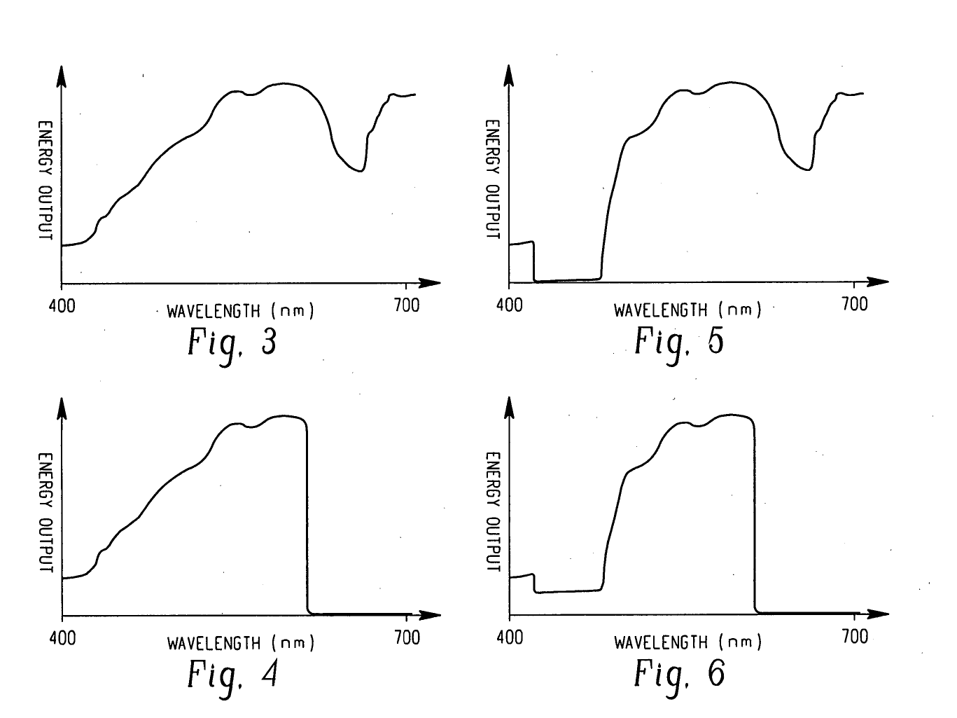

FIGS. 3 to 6 illustrate how two or more light modulating elements may cooperate to modulate the light produced by the source. FIG. 3 shows a typical light distribution from a source. FIG. 4 shows the effect of a first modulating element, such as element 82, on the light from the source. FIG. 5 shows the effect of a second modulating element, such as element 80, on the light from the source. FIG. 6 shows the resulting light output when the two elements are combined. It will be appreciated that since not all light strikes the reflector, a portion of the light is only modulated by the first modulating element 82. Thus, the resulting light output takes into account the combination of modulations.

The invention has been described with reference to the exemplary embodiments. Obviously, modifications and alterations will occur to others upon reading and understanding the preceding detailed description. It is intended that the invention be construed as including all such modifications and alterations.

What is claimed is:

1. A lamp comprising:
a housing;
a light source disposed within the housing; and
a plurality of light modulating elements, each of the light modulating elements modulating the visible light emitted by the source intermediate the source and an exterior of the housing, a first of the light modulating elements modulating light in at least one region of the visible portion of the electromagnetic spectrum differently from a second of the light modulating elements.

2. The lamp of claim 1, wherein at least one of the light modulating elements comprises an optical interference coating.

3. The lamp of claim 2, wherein at least two of the light modulating elements comprise an optical interference coating.

4. The lamp of claim 3, wherein the interference coating which comprises a first of the optical interference coatings differs from a second of the optical interference coatings in at least one of:
a number of optical interference layers;
a thickness of at least one of the optical interference layers; and
a composition of at least one of the optical interference layers.

5. The lamp of claim 1, wherein the first light modulating element modulates the light in a first region of the visible spectrum and the second light modulating element modulates the light in a second region of the visible spectrum.

6. The lamp of claim 1, wherein at least a portion of the light emitted by the source is modulated by both the first and second light modulating elements.

7. The lamp of claim 1, wherein the lamp includes at least two of an envelope which surrounds the source, a shroud spaced from the envelope, a reflector, which reflects light from the source, and a cover lens which transmits light which has been reflected by the reflector and the first light modulating element is associated with one of the envelope, the shroud, the reflector, and the cover lens and the second light modulating element is associated with another of the envelope, the shroud, the reflector, and the cover lens.

8. The lamp of claim 7, wherein the transmittance of the lamp at a given wavelength is given by the expression:
T_{SYSTEM}(λ)=(C₂×T_{F}×MF_{F}+[C₁×T_{F}×MF_{F}]×MF_{R})×MF_{CL}
where C₁ and C₂ are constants indicating the relative amounts of energy emitted from the envelope which are directed toward and away from the reflector respectively;
T_{F}=total light emitted by the envelope, prior to modulation;
MF_{F}=a modulation function of a light modulating element associated with the envelope;
MF_{R}=is a modulation function of a light modulating element associated with the reflector;
MF_{CL}=is a modulation function of a light modulating element associated with the cover lens;
and wherein MF_{F}, MF_{R} and MF_{CL} all differ by at least 5% for at least 10% of all wavelengths in the visible range of the spectrum.

9. The lamp of claim 1 wherein the light source comprises at least one of a filament and an arc discharge.

10. A lamp comprising;
a housing;
a light source disposed within the housing; and
at least three light modulating elements, each of the light modulating elements modulating at least a portion of the light emitted by the source intermediate the source and an exterior of the housing such that light emitted by the lamp includes light modulated by the three light modulating elements.

11. The lamp of claim 10, wherein at least one of the light modulating elements comprises an optical interference coating.

12. The lamp of claim 11, wherein at least two of the light modulating elements comprise an optical interference coating.

13. The lamp of claim 10, wherein the first light modulating element modulates the light in a first region of the visible spectrum and the second light modulating element modulates the light in a second region of the visible spectrum.

14. The lamp of claim 10, wherein at least a portion of the light emitted by the source is modulated by the first, second, and third light modulating elements.

15. The lamp of claim 10, wherein the lamp includes at least two of an envelope which surrounds the source, a shroud spaced from the envelope, a reflector, which reflects light from the source, and a cover lens which closes off an end of the housing and wherein the first light modulating element is associated with a first of the envelope, the shroud, the reflector, and the cover lens, the second light modulating element is associated with a second of the envelope, the shroud, the reflector, and the cover lens and the third light modulating element is associated with a third of the envelope, the shroud, the reflector, and the cover lens.

16. A lamp comprising:
a housing;
a light emitting source disposed within the housing;
optionally, an envelope which surrounds the light source and which transmits at least a portion of the light from the source;
optionally a shroud, spaced outwardly from the envelope, which transmits at least a portion of the light from the source;
optionally a reflective surface which reflects at least a portion of the light emitted by the source;
optionally a cover lens which closes an end of the housing and which transmits at least a portion of the light emitted by the source;
a first optical interference coating associated with a first of the envelope, the shroud, the cover lens, and the reflective surface; and
a second optical interference coating associated with a second of the envelope, the shroud, the cover lens, and the reflective surface.

17. The lamp of claim 16, further comprising:
a third optical interference coating associated with a third of the envelope, the shroud, the cover lens, and the reflective surface.

18. A method of achieving a desired spectral distribution comprising:
modulating light emitted by a source with a first light modulating element;
modulating light emitted by the source with a second light modulating element, the second light modulating element being spaced from the first light modulating element o receive light modulated by the first light modulating component; and
outputting light modulated by at least the first and second light modulating elements to achieve light of the desired spectral distribution.

19. The method of claim 18, wherein the modulation of the light with the first light modulating element includes changing the spectral distribution of the light and the modulation of the light with the second light modulating element includes changing the spectral distribution of the of the light.

20. The method of claim 18, wherein at least one of the modulation with the first light modulating element and the modulation with the second light modulating element includes transmitting the light through an optical interference coating.

21. The method of claim 18, wherein the first light modulating element is associated with a first lamp component selected from an envelope, a shroud, a reflective surface and a cover lens, and the second light modulating element is associated with a second lamp component selected from an envelope, a shroud, a reflective surface and a cover lens.

22. The method of claim 18, further comprising modulating at least a portion of the light emitted by the source with a third light modulating element, the third light modulating element being spaced from the first and second light modulating elements.
